(19) United States
(12) Patent Application Publication
(10) Pub. No.: US 2020/0158077 A1
(43) Pub. Date: May 21, 2020

(54) P3M3 SL

(71) Applicant: Edgardo Co Timcang, Vallejo, CA (US)

(72) Inventor: Edgardo Co Timcang, Vallejo, CA (US)

(21) Appl. No.: 16/350,475

(22) Filed: Nov. 20, 2018

(51) Int. Cl. F03B 17/04

(52) U.S. Cl. CPC F03B 17/04

(57) ABSTRACT

When water is pumped manually to the overhead tank or from a deep well, the weight of the water is felt on the opposite end of the lever which is the handle. Thus, an equal weight to counter that water weight is thought of to make pumping easier. This idea works only on drawing or extracting water from the well or source but not after, since the idea of perfect balance no longer works due the closed valve of the water pump which the water inside the pipe can no longer act as counter balancing weight. Attached is Exhibit A, a simple diagram of a water pump depicting three stages of pumping process as explained above.

Unlike conventional water pumps, P3M3 SL works continuously using techniques (the invention) that employ the underlying Principles of Equilibrium or Perfect Balance. These techniques constitute the secret of P3M3 SL, a very powerful single lever perpetual motion machine adapting the Rest Rod Balancing Technology capable of using equal or heavier weights to counter the weights on the other end of the lever on both the Input and the Output Process. Example: since it is perfectly balanced, pumping out 2 cubic meters of water per stroke through a 1.6-meter diameter 100-meter high pipe, with total water Weight of 200 tons, becomes an easy task for P3M3 SL since it is only the friction or mechanical losses of very few moving parts and the behavior of the pressurized hydraulic fluid or water that must be overcome. This is the reason why P3M3 SL is a very powerful machine!

### BACKGROUND OF THE INVENTION

My quest for a machine that runs without the need of any fossil fuel, nuclear, or any prime mover that needs consumable materials or elements, started in August 1970 in my Earth Science subject. Henceforth, I searched and studied perpetual motion machines run by gravity, flywheel, spring, electromagnet, but I found out all are bulky and impracticable since most of them will stop running even if a minuscule weight is loaded. I concentrated on known renewable energies as well, but all have limitations and drawbacks. The search went on until I was engaged in water pump using lever.

### BRIEF SUMMARY OF THE INVENTION

In general, the principle and concept adapted by P3M3 SL, along with its predecessors, is the Perfect Balance. It adapts the principles of equilibrium where a lever is used to pump water, air, oil, or to create pressure. In mid 1980s I became interested in water pumps technology. Example (please refer to Exhibit A): If the weight of the water inside a deep well pump with a length of 40-foot pipe is 20 kgs., that is from the tip of the lever where the piston is attached to the connecting rod, all the way down to the tip of the pipe, is counterbalanced by the same weight (20 kgs) on the other end of the lever, which is the tip of the handle, then pumping out half liter or 0.5 kg of water (Output Operation) can be made even through the tip of my finger. Now the big problem is how to get back from the previous position of the lever (which is from FIG. A, FIG. B to FIG. C) where the weight of the water inside the 40-foot pipe can no longer act as a counterbalance since the valve is closed. The same problem will occur! Only this time, the weight problem is shifted to the counterweight instead of the water weight. How to get back from the previous position, which is FIG. A is the invention, which is the object this patent application.

### BRIEF DESCRIPTION OF THE SEVERAL VIEWS OF DRAWINGS

To preclude obstruction of the view of the P3M3 SL machine's parts specifically the vital parts and moreover, to visualize clearly the operation and the workability of P3M3, the frame, foundation and platform are not drawn and some parts' length and width are expanded, rearranged for clearer picture but do not affect the presentation of the process. Actually, the drawings expound only on how P3M3 SL works as a prime mover using the Techniques and Principles of Perfect Balanced and not on how the discharged highly pressurized Hydraulic Oil or Water drives the Turbine attached to the Generator.

### 1) The P3M3 SL Machine in Perspective

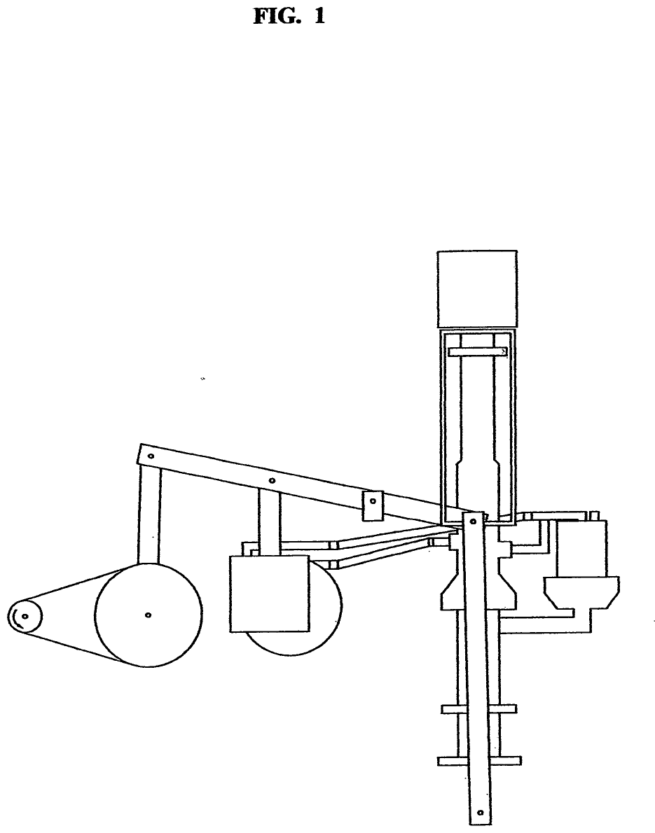

FIG. 1. The Front View of P3M3 SL—depicts the front view of the non-labeled parts of P3M3 SL.

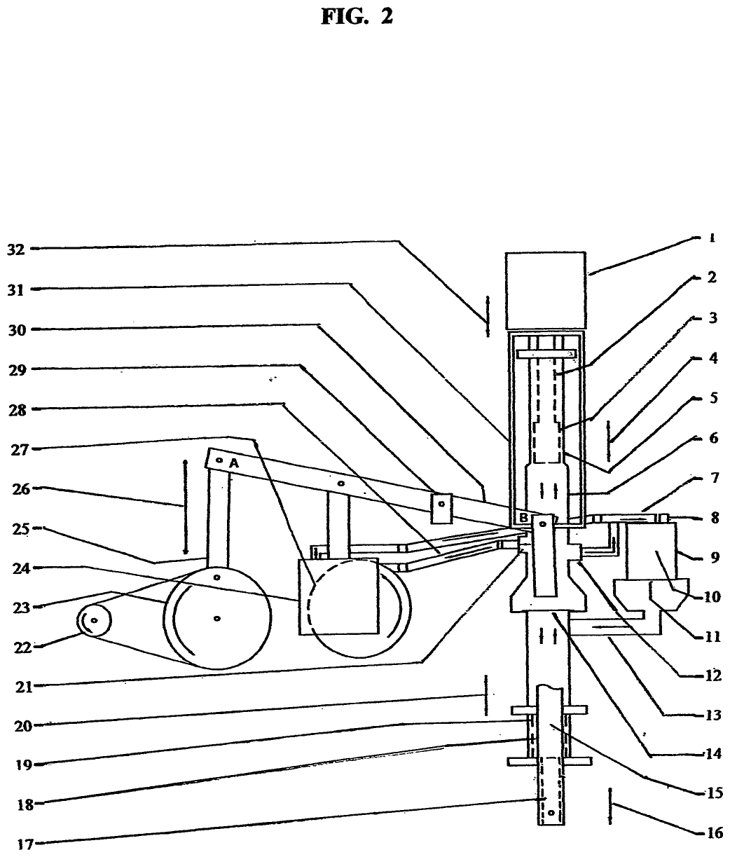

FIG. 2. The Front View of P3M3 SL with labeled parts—depicts all labeled parts of the machine and their functions.

### 2) P3M3 SL During the Discharge/Output Process

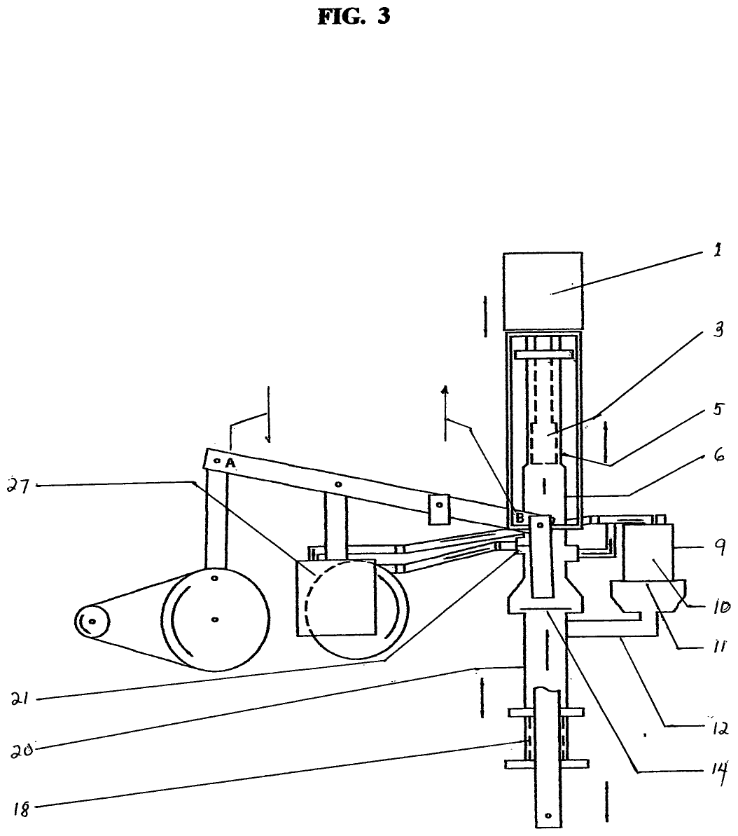

FIG. 3. The Start Position of Discharge/Output Process (or End Position of Intake Process)—depicts the starting position of P3M3 SL.

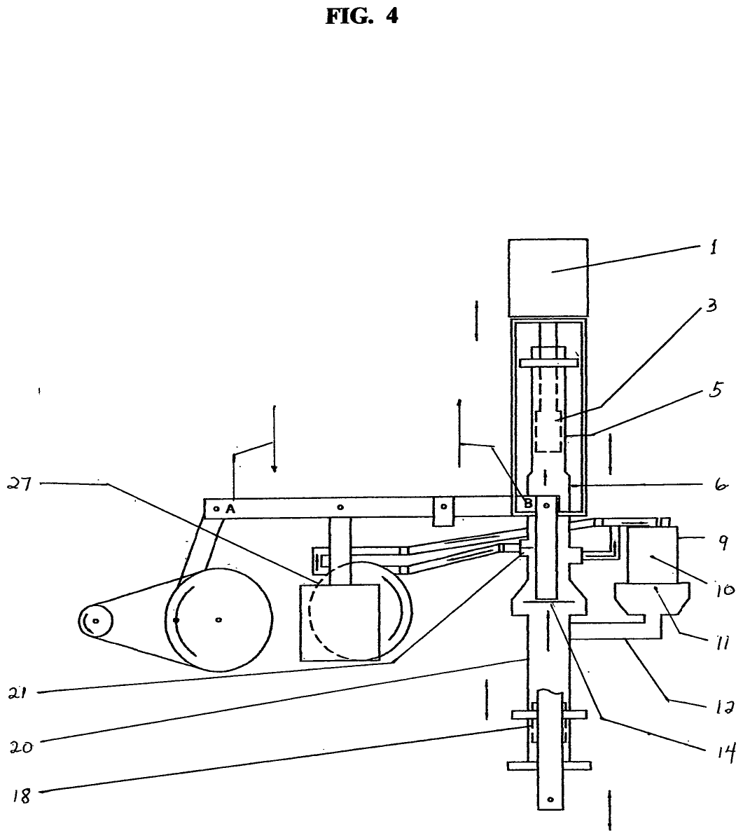

FIG. 4. The Continuing Position of Discharge/Output Process—depicts how the P3M3 SL discharges the Hydraulic Oil 10 into the Cylinder 6 which half of it is going to the Turbine and Electric Generator 27 thereby running it and the other half into the Weight Pressure Chamber 5 during Discharge/Output Process while simultaneously depicting the movements and positions of Intake Discharge Piston 18, Pressure Weight Piston 3, Intake Valve 11 and Discharge Valve 14.

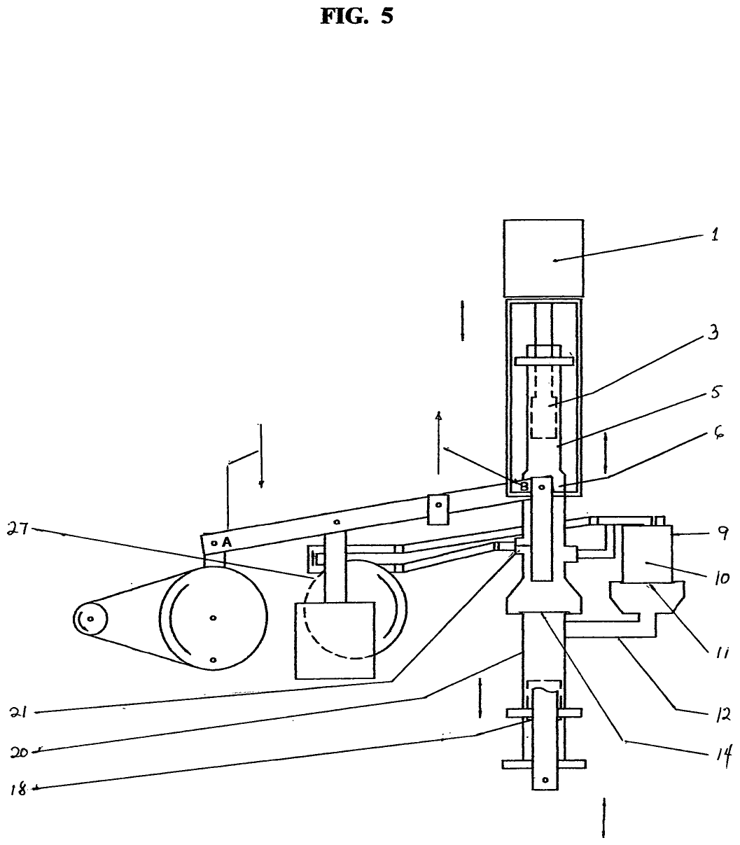

FIG. 5. The End Position of Discharge/Output Process—(or Start Position of Intake Process) depicts the ending position of P3M3 SL.

### 3. P3M3 SL During the Intake/Output Process

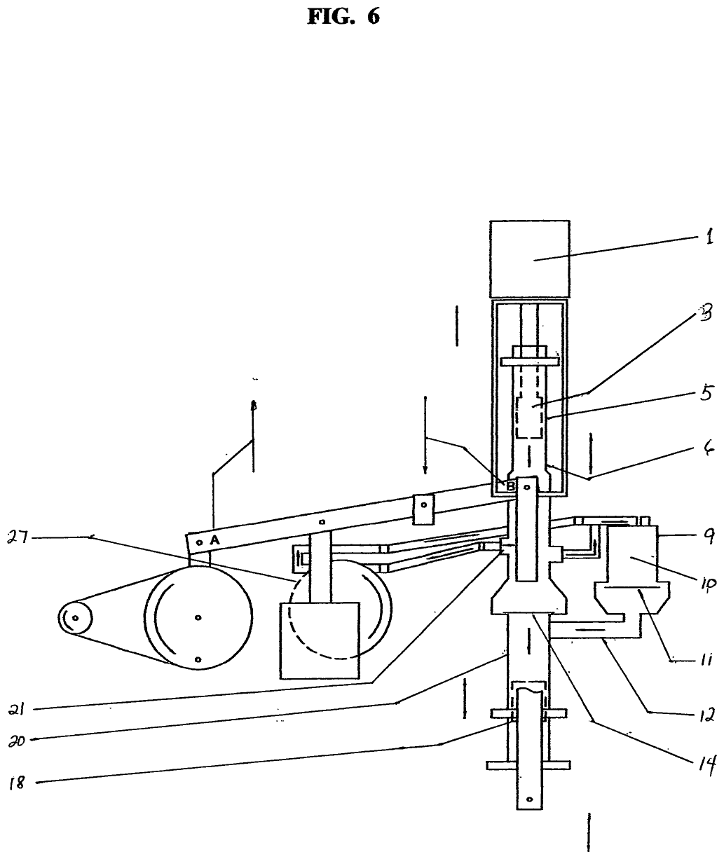

FIG. 6. The Start Position of Intake/Output Process—(or End Position of Discharge/Output Process)—depicts the starting position of P3M3 SL.

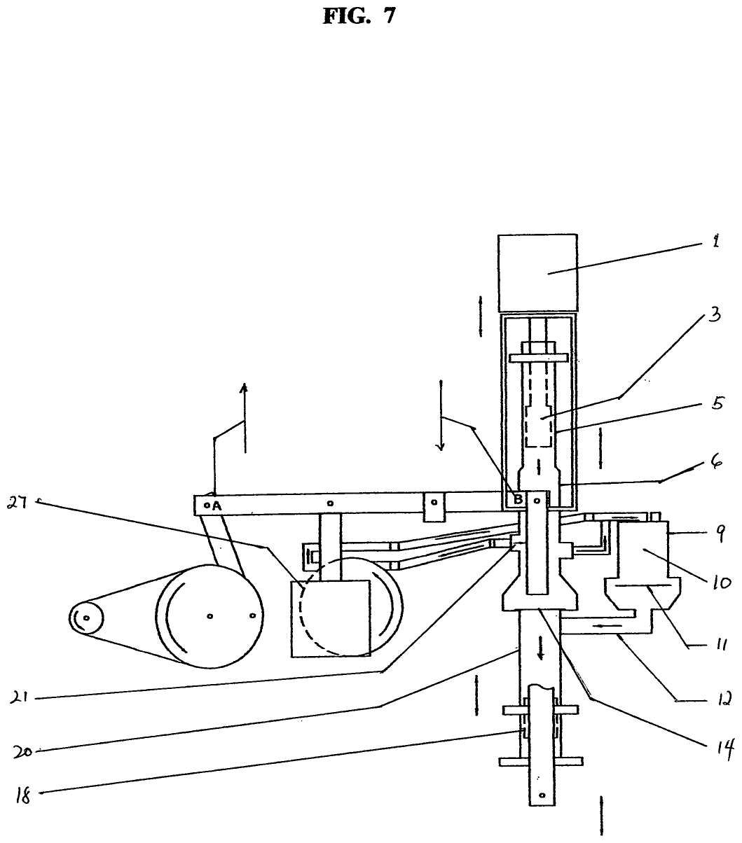

FIG. 7. The Continuing Position of Intake/Output Process—depicts how P3M3 SL draws Hydraulic Oil 10 from the Hydraulic Oil Tank 9 into the Intake/Discharge chamber 19 during the Intake/Output Process while simultaneously pushing the Hydraulic Oil 10 towards the Turbine and Electric Generator 27 while also depicting the movements and positions of the Intake/Discharge Piston 18, Weight Pressure Piston 3, Intake Valve 11 and the Discharge Valve 14.

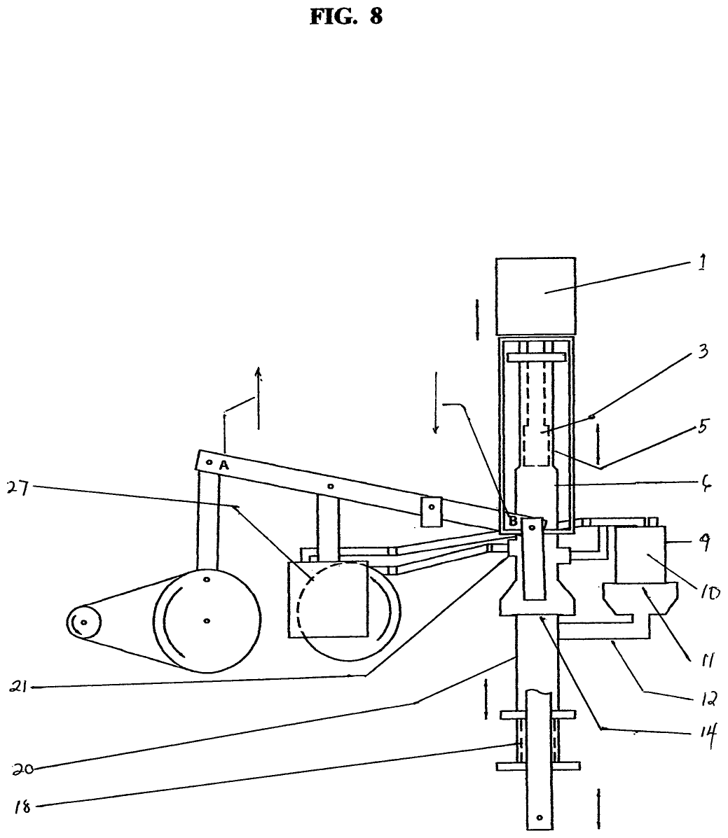

FIG. 8. The End Position of Intake/Output Process (or Start Position of Discharge/Output Process)—depicts the ending position of P3M3 SL.

### 4. P3M3 SL Other Applications Drawings

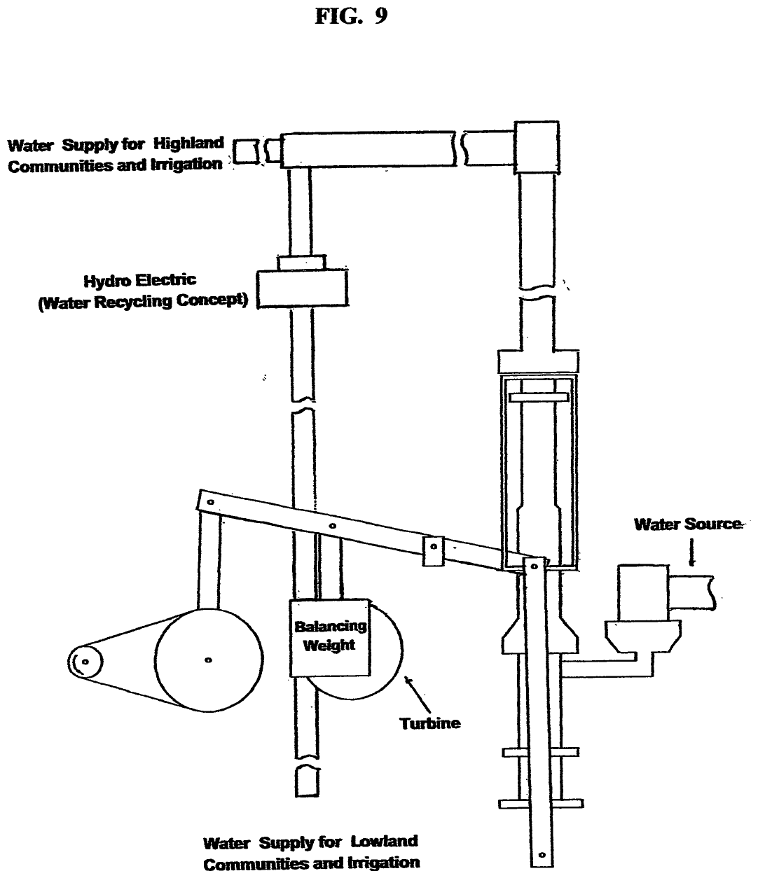

FIG. 9. The P3M3 SL Drawing as a Water Pump—the drawing depicts P3M3 SL as a water pump. This version of P3M3 SL design is to pump water for Hydroelectric Water Recycling Concept, hotels and condominium, highland cities and communities, irrigation for highland farming, etc.

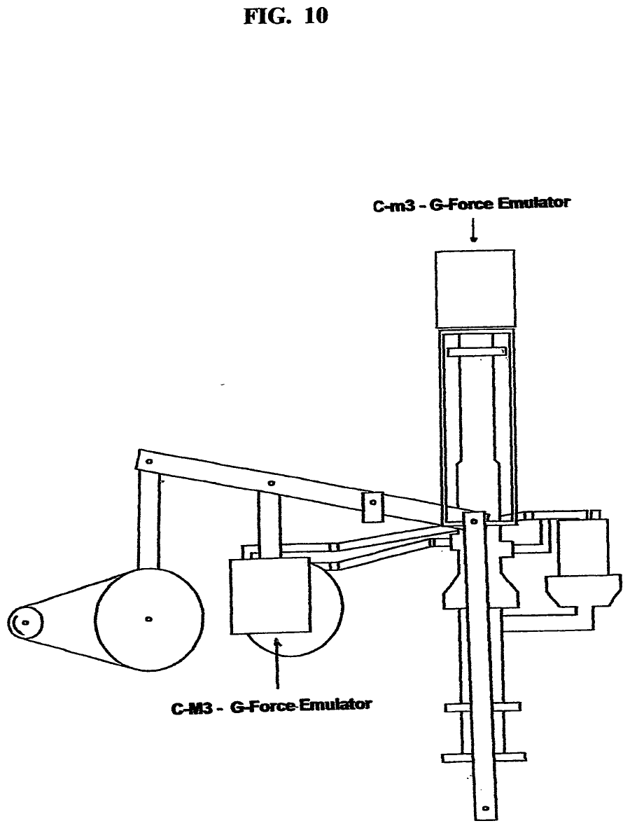

FIG. 10. The P3M3 SL Drawing With G-Force Emulator or C-M3—the drawing depicts the P3M3 SL adapting the G-Force Emulator technology replacing Weight Pressure 1 and Balancing Weight 24. This design is the compact version of P3M3 SL and is intended to replace fossil-fuel-feed engines and other prime movers. However, for purposes of presentation, I just used the same drawing with minor alteration.

### DETAILED DESCRIPTION OF THE INVENTION

In all honesty, P3M3 SL's technical aspect is simple. P3M3 SL is a machine of basic of all basics. It works primarily on the techniques and underlying the Principles of Equilibrium. But how does P3M3 SL handle the Input and Output Operations, the known problem since man existed? P3M3 SL has employed simple techniques that have not been discovered since time immemorial? These techniques are fully described and consolidated in the illustration of P3M3 Embodiments.

### 1) P3M3 SL Components

A. Weights—since we are dealing with weights, I need to define and described the two most important actual weights significant to the machine's workability.
   1. Weight Pressure (pressure created by the weight)—the total weight of 1, 2 and 5.
   2. Balancing Weight—the calculated weight to equally counter the weight of Weight Pressure 1.
      Note: travel restrictions, guides, stands, levers, and rod are not included in the weight computation since they are already balanced before establishing the weight requirements.
B. Parts and Functions
   1. Weight Pressure—(or Water Weight)—the calculated weight that creates pressure power required by an application.
   2. Weight Pressure Connecting Rod—the rod that connects the Weight Pressure 1 to the Weight Pressure Piston 3.
   3. Weight Pressure Piston—used by the Weight Pressure 1 to push the Hydraulic Oil 10 out to the Open Gate Valve 21, in this case, into the turbine of the Turbine and Electric Generator 27.
   4. Weight Pressure Piston Travel—the restricted up-and-down movement of the Pressure Weight Piston 3.
   5. Weight Pressure Chamber—part of the Cylinder 6 where Weight Pressure Piston 3 travels and pushes the Hydraulic Oil 10 down to the Gate Valve 21 to run the Turbine and Electric Generator 27.
   6. Cylinder—the pipe that stretched from the Intake/Discharge Piston 18 to the Weight Pressure Piston 3.
   7. Hydraulic Oil Receiver Conduit—the conduit where discharged Hydraulic Oil 10 exiting from the Turbine and Electric Generator 27 and the Check Valve 12 flows back to the Hydraulic Oil Tank 9.
   8. Hydraulic Tank Air vent—ensures air flow into the Hydraulic Oil Tank 9 during the Intake/Output Process and Discharge/Output Process.
   9. Hydraulic Oil Tank—stores the recycled Hydraulic Oil 10 coming from the Hydraulic Oil Receiver Conduit 7 during the Discharge/Output Process and releases the Hydraulic Oil 10 during the Intake/Output Process.
   10. Hydraulic Oil (or water or air)—the life blood of P3M3 SL.
   11. Intake Valve—opens during the Intake/Output Process and closes during the Discharge/Output Process.
   12. Check Valve—checks the and maintains the desired pressure inside the Cylinder 6 during the Discharge/Output Process and the Intake/Output Process.
   13. Intake Supply Pipe—conduit between the Hydraulic Oil Tank 9 and the Intake/Discharge Chamber 19 where the Hydraulic Oil 10 is stored.
   14. Discharge Valve—opens during the Discharge/Output Process, closes during the Intake/Output Process.
   15. Intake/Discharge Piston and Balancing Weight Lever Pull Rod—the push and pull rod that directly connects the Intake/Discharge Piston 18 to the Intake/Discharge Piston and Balancing Weight Lever 30.
   16. Intake/Discharge Piston and Balancing Weight Lever Pull Rod Travel—the restricted up-and-down movement of the Intake/Discharge Piston and Balancing Weight Lever Pull Rod 31.
   17. Intake/Discharge Piston Connecting Rod—the connecting rod that connects the Intake/Discharge Piston 18 to the Intake/Discharge Piston and Balancing Weight Lever Pull Rod 15.
   18. Intake/Discharge Piston—draws the Hydraulic Oil 10 from Hydraulic Oil Tank 9 through the Intake Supply Pipe 13 and stores it into the Intake/Discharge Chamber 19 during the Intake/Output Process and discharges it into the Cylinder 6 up to the Weight Pressure Chamber 5 during the Discharge/Output Process.
   19 Intake/Discharge Piston Travel—the restricted up-and-down movement of the
   20. Intake/Discharge Chamber—part of the Cylinder 6 where drawn Hydraulic Oil 10 is stored during the Intake/Output Process and releases it during the Discharge/Output Process.
      Intake/Discharge Piston 18.
   21. Gate Valve—where Hydraulic Oil 10 from Weight Pressure Chamber 5 passes through going into the Discharge Hydraulic Pipe 28 driving the turbine of the Turbine and Electric Generator 27. This valve is open during the Discharge/Output Process and Intake/Output Process.
   22. Crankshaft Driver Electric Motor—drives the Crankshaft 23 which push and pull the Intake/Discharge Piston and balancing Weight Lever 30.
   23. Crankshaft—designed to push and pull the Intake/Discharge Piston and Balancing Weight Lever 30.
   24. Balancing Weight—the calculated weight to counter the total weight of the Weight Pressure 1.
   25. Crankshaft Connecting Rod—connects the Crankshaft 23 to the Intake/Discharge Piston and Balancing Weight Lever 30 (A).
   26. Intake/Discharge Piston and Balancing Weight Lever Travel—the restricted up-and-down movement of the Intake/Discharge Piston andBalancing Weight Lever 30.
   27. Turbine and Electric Generator—generates electricity.
   28. Discharge Hydraulic Pipe—this is where the highly pressurized Hydraulic Oil 10 passes through going into the Turbine and Electric Generator 27.
   29. Intake/Discharge Piston and Balancing Weight Lever Stand—the stand that holds in place the Intake/Discharge Piston and Balancing Weight Lever 30.
   30. Intake/Discharge Piston and Balancing Weight Lever—the lever of which the Balancing Weight 24 and Intake/Discharge Piston 18 are anchored.
   31. Weight Pressure Rest Rod—actually, this is part of the Intake/Discharge Piston and Balancing Weight Lever 30 wherein the Weight Pressure 1 rest immediately after the Discharge/Output Process and the Intake/Output Process cycles are completed.
   Note: the Weight Pressure Rest Rod 31 is aligned with and on top of the Intake/Discharge Piston and Balancing Weight Lever Pull Rod 15. However, to prevent obstruction the rod drawing of Weight Pressure Rest Rod 31 is just drawn along the side Cylinder 6.
   32. Weight Pressure Travel—the restricted up-and-down movement of the Weight Pressure 1.

### 2. The Input/Output Operations of P3M3

A. Discharge/Output Process—the process where the Intake/Discharge Piston 18 discharges Hydraulic Oil 10 from the Intake/Discharge Chamber 19 going through the Discharge Valve 14 and Cylinder 6 of which half of it goes to Turbine and Electric Generator and finally the other half goes to the Weight Pressure Chamber 5. In this process, the Intake Valve 11 is closed while the Discharge Valve 14 is open. The Intake/Discharge Piston and Balancing Weight Lever 30's Tip A travels in a downward direction while its Tip B travels in an upward direction.
B. Intake/Output Process—the process where the Intake/Discharge Piston 18 draws Hydraulic Oil 10 from the Hydraulic Oil Tank 9 which passes through the Intake Valve 11, the Intake Pipe 13 and finally stores it in the Intake/Discharge Chamber 19. In this process, the Intake Valve 11 is open while the Discharge Valve 14 is closed. Intake/Discharge Piston and Balancing Weight Lever 30's Tip A travels in upward direction while its Tip B travels in a downward direction.

### 3. P3M3 SL Housekeeping

Before running the P3M3 SL, whether it is the first time or from repair or maintenance the following housekeeping must be undertaken:
A. Calibration/Preparation
   1. Balancing Weight—the calculated weight to counter the weight of Weight Pressure 1.
   2. Momentum Spring—to be calibrated on how to counter the momentum of one end of the lever that has downward force where upon reaching the end of the travel the compressed Momentum Spring can give a backward push.
   3. Friction or Mechanical Losses—calculating how much energy or force needed to determine the Crankshaft Drive Motor 22 power to overcome the friction and the pressurized Hydraulic Oil 10 behavior to run the Turbine and Electric Generator 27 according to the desired revolution per minute RPM.
B. Priming
   Filling the Hydraulic Oil Tank 9 the amount of Hydraulic Oil 10 needed by the Intake/Output Process and Discharge/Output Process.

### 4) P3M3 SL Embodiment

The Intake/Output Process and Discharge/Output Process—The running of the Electric Generator of which the P3M3 is the prime mover.
With most, if not all, of P3M3 SL's significant terminologies have been defined and their functions described, I hope that with the aid of drawings P3M3 SL's workability can be easily understood. Please note that with the P3M3 SL Start Position of the Intake/Output Process FIG. 6 and the P3M3 SL End Position of the of the Discharge/Output Process FIG. 5 are the same except that the latter (FIG. 5) the Weight Pressure 1 rested on the Weight Pressure Rest Rod 31. Likewise, the End Position of the Intake/Output Process FIG. 8 and the Start Position of the Discharge/Output Process FIG. 1 are also the same except that the former (FIG. 8) the Weight Pressure 1 rested on the Weight Pressure Rest Rod 31. Although there is a sort of drawing duplication, the objective is to show clearly both the Intake Valve 11 and the Discharge Valve 14 of the above processes are closed, a complete process that is from the start to end of both processes. There are also similarities between the drawings of the Continuing Position of Discharge/Output Process FIG. 4 and the Continuing Position of Intake/Output Process FIG. 7. However, the difference between the two is their valve positioning, the Intake Valve 11 is open while the Discharge Valve 14 is closed during the Intake/Output Process while the Intake Valve 11 is closed, and the Discharge Valve 14 is open during the Discharge/Output Process. Moreover, in the continuing position, the Crankshaft Connecting Rod 25 in Discharge/Output Process FIG. 4 is on the left while in the Intake/Output Process FIG. 7 the Crankshaft Connecting Rod 25 is on the right.
   A. Discharge/Output Process
      In this process, the Intake/Discharge Piston 18 discharges the pressurized Hydraulic Oil 10 from the Intake Discharge Chamber 20 going into the Cylinder 6 towards its destinations which is the Turbine and Electric Generator 27 and Weight Pressure Chamber 5. Please note that once the Intake/Discharge Piston 18 starts discharging the Hydraulic Oil 10 the Weight Pressure 1 leaves the Weight Pressure Rest Rod 31.
      1. FIG. 3 The Start Position of Discharge/Output Process
         A. Valves—Discharge Valve 14 and Gate Valve 21 open, Intake Valve 11 close.
         B. Lever and Piston Directions—Tip A, starts traveling downward. Tip B, Intake/Discharge Piston 18 and Weight Pressure Piston 3 start traveling upward.
         C. Intake/Discharge Piston 18 starts discharging the Hydraulic Oil 10 from the Intake/Discharge Chamber 20 going into Cylinder 6 creating tremendous pressure due to Weight Pressure's 1 counter force. During the discharging process around half of the discharged Hydraulic Oil 10 passing through the opened Gate Valve 21 and flows towards the turbine of the Turbine and Electric Generator 27 while the other half into the Weight Pressure Chamber 5. Please refer to FIGS. 3,4, and 5.
      2. FIG. 4 The Continuing Position of Discharge/Output Process
         A. Valves—Discharge Valve 14 and Gate Valve 21 remain opened; Intake Valve 11 remain closed.
         B. Lever and Piston Directions—Tip A, continues traveling downward. Tip B, Intake/Discharge Piston 18 and Weight Pressure Piston 3 continues traveling upward.
         C. Intake/Discharge Piston 18 continues discharging the Hydraulic Oil 10 from the Intake/Discharge Chamber 20 into Cylinder 6 going to the Weight Pressure Chamber 5 and Turbine and Electric Generator 27 maintaining the constant pressure.
      3. FIG. 5 The End Position of Discharge/Output Process
         A. Valves—Discharge Valve 14 and Gate Valve 21 closed; Intake Valve 11 closed.
         B. Lever and Piston Directions—Tip A, stops traveling downward. Tip B, Intake Discharge Piston 18 and Weight Pressure Piston 3 stop traveling upward.
         C. Intake/Discharge Piston 18 stops discharging the Hydraulic Oil 10 while half of the discharged Hydraulic Oil 10 stops flowing towards the Turbine and Electric Generator 27 and Weight Pressure Chamber 5.
   A. Intake/Output Process
      In this process, the Intake/Discharge Piston 18 draws Hydraulic Oil 10 from the Hydraulic Tank 9 all the way to the Intake/Discharge Chamber 19 while the Weight Pressure Piston 3 pushes the Hydraulic Oil 10 towards the Turbine and Electric Generator 27 thereby running it. Please note that immediately before the Intake/Output Process starts the Weight Pressure 1 already rested on the Weight Pressure Rest Rod 30.
      1. FIG. 6 The Start Position of Intake/Output Process.
         A. Valves—Intake Valve 11 and Gate Valve 21 open; Discharge Valve 14 closes.
         B. Lever and Piston Directions—Tip A starts traveling upward. Tip B, Intake/Discharge Piston 18 and Weight Piston 3 start traveling downward.
         C. Intake/Discharge Piston 18 starts drawing the Hydraulic Oil 10 from the Hydraulic Oil Tank 9 through the Intake Supply Pipe 13 and storing it into the Intake/Discharge Chamber 20.
      2. FIG. 7 The Continuing Position of Intake/Output Process
         A. Valves—Intake Valve 11 and Gate Valve 21 remain opened; Discharge Valve 14 remain closed.
         B. Lever and Piston Directions—Tip A continues traveling upward. Tip B, Intake/Discharge Piston 18 and Weight Pressure Piston 3 continue traveling downward.
         C. Intake/Discharge Piston 18 continues drawing Hydraulic Oil 10 from the Hydraulic Oil Tank 9 while Weight Pressure 3 continues pushing the Hydraulic Oil 10 towards the Turbine and Electric Generator 27 thereby running it.
      3. FIG. 8 The End Position of Intake/Output Process
         A. Valves—Intake Valve 11 and Gate Valve 21 closed; Discharge Valve 14 closed.
         B. Lever and Piston Directions—Tip A stops traveling upward. Tip B, Intake/Discharge Piston 18 and Weight Pressure Piston 3 stop traveling downward.
         C. Intake/Discharge Piston 18 stops drawing Hydraulic Oil 10 from the Hydraulic Oil Tank 9.
   C. P3M3 SL Other Applications Drawings
      Note: the inclusion of FIG. 9 The P3M3 SL Drawing as a Water Pump and FIG. 10 The P3M3 SL Drawing With G-Force Emulator or C-M3 is just to show some of major applications of which it is used as a prime mover.
      1. FIG. 9 The P3M3 SL Drawing as a Water Pump.
      2. FIG. 10 The P3M3 SL Drawing with G-Force Emulator or C-M3.

1. the area of circle of Weight Pressure Chamber 5 is around half and the length is around twice than that of Intake/Discharge Chamber 19.

2. the Rest Rod (Weight Pressure Rest Rod 30) technology was developed and invented solely in order to attain the perfect balance right after the Discharge/Output Process is completed.

3. based on the above claims (number 1 and 2), P3M3 SL with installed Balancing Weight, can now work as perfect balance machine even when the Discharged Valve 14 is closed and is now capable of dual output technique which means that the Intake (input) and Discharge (output) Processes can be now both Intake/Output Process and Discharge/Output Process.

4. with the use of C-M3, the G-Force Emulator, with patent application No. U.S. Ser. No. 12/288,988, P3M3 SL can be made compact, lighter and a high RPM machine replacing fossil-fuel-feed engines or similar combustion powered engines.
